(19) United States
(12) Patent Application Publication
(10) Pub. No.: US 2006/0031230 A1
(43) Pub. Date: Feb. 9, 2006

(54) Data storage systems

(76) Inventor: Sinha Manish Kumar, New Delhi (IN)

Correspondence Address: HEDMAN & COSTIGAN P.C., 1185 AVENUE OF THE AMERICAS, NEW YORK, NY, 10036, US

(21) Appl. No.: 11/185,469

(22) Filed: Jul. 20, 2005

Related U.S. Application Data
(60) Provisional application No. 60/590,037, filed on Jul. 21, 2004.

(51) Int. Cl. G06F 17/30

(52) U.S. Cl. 707/10

(57) ABSTRACT

The invention discloses an apparatus for storage of data in a distributed storage environment and a method of efficiently storing data in such an environment which includes a set of client nodes, a set of storage nodes, meta data nodes and an administrator node, each node having processing and memory capability. The client nodes can directly access data files stored in the form of “stripes” across the storage nodes without querying the meta data node by using specially created file identifiers and storage identifiers.

### CROSS-REFERENCE TO RELATED APPLICATIONS

This applications claims the benefit of priority from U.S. Provisional Application Ser. No. 60/590,037, filed Jul. 21, 2004, the contents of which are incorporated herein by reference.

The present invention relates to data storage systems.

More particularly, the invention describes a mechanism for achieving true parallel Input/output access between a processing and storage components of a cluster. This results in a system with faster performance, greater scalability and reduced complexity.

### TECHNOLOGY BACKGROUND

The last few years have seen an explosion in the amount of electronic data being generated and stored. In research labs and within corporate data centers the performance and scalability demands placed upon the storage and retrieval system is highest. Distributed data storage or clustered storage and methods to store and retrieve information from files within such storage have been an important area of interest.

Many approaches to storing and accessing information have been biased by the type of information being stored. For instance U.S. Pat. No. 6,892,246 describes a method to store Video Data and U.S. Pat. No. 6,826,598 describes a method to store location-based information in a distributed storage environment. In each of these approaches the technique used leverages the knowledge of the type of the data to provide fast and efficient access to it. Again, Guha in U.S. Pat. No. 6212,525 discloses a hash-based system and method with primary and secondary hash functions for rapidly identifying the existence and location of an item in a file. In this system a hash table is constructed having a plurality of hash buckets, each identified by a primary hash key. Each hash entry in each hash bucket contains a pointer to a record in a master file, as well as a secondary hash key independent of the primary hash key. A search for a particular item is performed by identifying the appropriate hash bucket by obtaining a primary hash key for the search term. Individual hash entries within the hash bucket are checked for matches by comparing the stored secondary keys with the secondary key for the search term. Potentially matching records can be identified or ruled out without necessitating repeated reads of the master file. This system does not provide means to locate where a file is stored in a distributed storage environment and presumes that the knowledge of this location is known. This system cannot be used for locating a file and is not applicable for storage of data in a distributed storage environment.

Lately, clusters are being increasingly used since they allow users to achieve the highest levels of performance and scalability while reducing the costs. Usually, more than one application runs on more than one server within a cluster with the data for each application residing within a common storage area. In this regards, various models have been proposed to allow high performance clusters efficient access to shared data with minimal access-latency. Distributed file systems give programs running on different nodes access to a shared collection of files, but they are not designed to handle concurrent file accesses efficiently. Parallel file systems do handle concurrent accesses, and they stripe files over multiple storage nodes to improve bandwidth.

A popular high-performance data-sharing model used within cluster networks is a cluster parallel file system. A cluster parallel file system is in most ways is similar to a parallel file system and has the following characteristics: a) A client-side installable software (Client here refers to the processing node on which the application executes) b) A meta-data server that manages the file/directory namespace and hierarchy and also manages the file-object mappings c) A set of storage nodes that store the actual objects or portions of the file. Meta-data management includes two layers: file-directory namespace management and file-inode management. In Shared file system model, clients collaborate amongst themselves for managing both layers of the meta-data management and this consumes a considerable percentage of their CPU and bandwidth resources. In cluster parallel file systems the first layer is managed by the meta-data server while the second layer is internally managed by the storage nodes that, as opposed to block-based storage devices such as RAID arrays, have processing capability of their own. These file systems are more efficient than shared file systems such as SAN file systems since they relieve the client node from managing the meta-data associated with the files stored in the system. Cluster parallel file systems also provide greater scalability since the inode management is now distributed over the set of storage nodes and this help the system perform efficiently even with extremely large number of data files and sizes.

### DESCRIPTION OF THE PROBLEM BEING SOLVED

In most clusters, studies of input-output patterns suggest that in general applications make a great number of accesses for small pieces of data instead of smaller number of accesses for large chunks of data. So on an average the number of file input/output operations are very high. In existing systems every access to a file requires the client node to query the meta-data server for the file-object mapping and then only contact the actually storage node. The file-object mapping typically provides the list and order of objects that the file has been broken into and the exact address of the storage node that houses each object. Since the mapping may be frequently changing as a result of file write operations or even storage node failure, it is not possible for the client to assume that the mapping are fixed. So every file input/output is a two-step procedure with the first step concentrated on the meta-data server.

A Step by Step flow of commands that confirms the two step procedure in case of ‘Read’ and ‘Write’ data operations is given in Page 12-13 of Prior Art reference—“Object Storage Architecture: Defining a new generation of storage systems built on distributed, intelligent storage devices” Whitepaper by Panasas Inc.

For large clusters that required hundreds of thousands of file I/O operations per second the meta-data server becomes the bottleneck and degrades the performance. Existing systems attempt to counter this using a cluster or distributed set of meta-data servers in a load-balanced configuration. However while this may resolve the bottleneck to an extent, it creates problems of its own. Each file meta-data mapping must now be updated across the cluster of meta-data servers and if the mapping is highly volatile then race conditions may occur between the concurrent accesses to different meta-data servers. This in turn limits the overall scalability of the system.

Therefore, it is desirable to have a system in which the meta-data overhead is completely eliminated from the file access sequence. This not only speeds up each file I/O operation by reducing the earlier two-step procedure to a single-step procedure, but also removes most of the complexity and traffic at the meta-data server, leaving it for only administrative tasks. In effect, such a system offers true parallel data access between the client and storage node.

### SUMMARY OF THE INVENTION

According to this invention there is provided distributed computing environment system comprising:
a first set of a plurality of nodes (Client Nodes) each such node being defined by processing means including a “requester” means, a “locator” means, a “transmitter” means and a “data-splitter” means; data storage means; memory means; input/output means and each said node being further defined and addressed by a globally unique identifier hereafter referred to as the “parameters” for each of said client node;
a second set of a plurality of nodes (Storage Nodes) differentiated form the first set by having enhanced data-storage capabilities and further defined by memory means; Input/output means; and processing means including “receiver” means, “data-retrieval” means and a “transmitter” means; each said node of the second set being further defined by a plurality of variable identifiers, a measurement of the total storage space and a measurement of the total available storage space in the node, together hereafter referred to as the “parameters” for each of said storage nodes;
at least one meta-data node adapted to manage data being inputted into and outputted form the second set of nodes and having a database of all files and their respective identifier stored in the said environment, processing means including “prefix generation” means, “file-identifier generation” means adapted to generate a globally unique identifier for a data file; said file identifier being defined by
   a “head” element that's derived from a hash of a pre-determined set of properties of the file
   a “next-prefix” element that is derived from the “prefix-generation” means
   a pre-determined “striping” element
   a pre-determined “sizing” element
at least one Administrative node having tool and utilities for accessing and configuring abovementioned parameters associated with each of said nodes and disseminating modified parameters of one node to all other nodes irrespective of their set;
an interconnect means that is connected to the Input/Output means of the first set of nodes, the second set of nodes, the meta-data node and the Administrative node; and adapted to facilitate one-to-one, one-to-many, many-to-one and many-to-many data communication between the nodes
said nodes in the first set adapted to initiate file operations within the computing environment; said file operation including file-create, file-read and file-write operations;
said “data splitter” means within the each node of the first set adapted to split a file into smaller “stripes” of size defined by the “sizing” element dependent upon the file-identifier generated for that file;
said “locator” means within each node of the first set adapted to receive a “file-identifier” of a file and further adapted to provide the “requestor” and “transmitter” means within the node with a designated sequence of nodes from the second set to which the requestor or transmitter means respectively must request from or transmit data to respectively;
said “transmitter” means within the each node of the first set adapted to receive the stripes of the file from the “data-splitter” and the sequence of nodes in the second set from the “locator” and to transmit entire data contained in a file to a designated sequence of nodes from the second set;
said “requestor” means within the each node of the first set adapted to receive a designated sequence of nodes from the second set from the “locator” means and further adapted to send a request for file stripe to an appropriate node in the second set;
said “prefix-generation” means at the meta-data node adapted to generate a “next-prefix” element for each node in the second set by using the parameters associated with that individual node;
said “identifier-generation” means at the meta-data node adapted to generate a unique identifier for a file and transmitting the identifier to the node within the first set responsible for creating a file;
said “receiver” means within the each node of the second set adapted to receive a request for data from the “requestor” or stripes of new or modified data form the “transmitter” within a node in the first set;
said “retrieval” means, upon trigger from the “receiver” means adapted to retrieve data form the storage media associated with the storage nodes and to deliver it to the “transmitter” means of the second set;
said “storage” means adapted to receive data from the “receiver” and store data onto a storage media; and
said “transmitter” means adapted to receive data from the “retrieval” means and further adapted to transmit data to the “requestor” means of the node from the first set that requested for that data.

Typically, In accordance with a preferred embodiment of this invention, the meta-data node may comprise a combination of more than one nodes that cooperate with each other to provide the said meta date node.

Typically, In accordance with a preferred embodiment of this invention the Administrative node is the meta-data node.

Typically In accordance with a preferred embodiment of this invention the Storage media of the storage node is external to the second set of nodes and is externally connected to the nodes.

Typically In accordance with a preferred embodiment of this invention, there are more than one instances of the “requester” and “transmitter” means in the first set of nodes to allow for parallel execution of requests from applications being executed on the node.

Typically In accordance with a preferred embodiment of this invention, there are more than one instances of the “receiver” and “transmitter” means in the second set of nodes to allow for parallel execution of requests from multiple nodes in the first set.

Typically In accordance with a preferred embodiment of this invention the “requestor” and the “transmitter” means in the first set of nodes are coupled into a single component.

Typically In accordance with a preferred embodiment of this invention the “receiver” and the “transmitter” means in the second set of nodes are coupled into a single component.

Typically In accordance with a preferred embodiment of this invention the “identifier generation” and the “prefix-generation” means are coupled into a single component on the meta-data node.

Typically the interconnect includes multiple devices that are directly interconnected to allow bidirectional communication between all of the nodes connected to any of the device.

Typically In accordance with a preferred embodiment of this invention the interconnect includes multiple devices that are indirectly connected via a secondary network such as the Internet and allow for bidirectional communication between all of the said nodes.

Typically, In accordance with a preferred embodiment of this invention, the meta-data node is one of the nodes in the first set of nodes.

The client nodes and/or the storage nodes may be characterized by more than one globally unique/variable identifiers.

The invention provides methods for data storage and retrieval in a cluster storage system within a distributed computing environment. In one aspect of the present invention, a system is provided for assigning identifiers from a circular namespace to a client and storage component of a cluster storage system. For routing and addressing decisions, the file system software on each component makes use of these identifiers instead of the actual network address of the component. The system also assigns unique identifiers for every file/object stored in the system and implements either a unique relationship between the file identifier and the storage node range of identifiers. This way a storage ‘head’ node is automatically designated for every file stored in the system. Another rule for storing large file is that all stripes of the file are of the same size and are striped in a linear fashion within the circular identifier namespace of storage nodes. A client node that logs into the system receives a list of directories and files along with the unique identifier for each file. With this information, the client can precisely guess the location of each stripe of every file.

Further, since the system uses automatic processes for data storage, a method to ensure that the data is equally spread across all storage nodes as amount of data grows is built into the system architecture. When further storage nodes are added to the system, then they can be made to share the load with the heaviest loaded storage node at that time.

With the client nodes interpreting the elements within the file identifier for gaining knowledge of the location of individual stripes of a file, the invention eliminates the need for querying the meta-data server for the file-stripe mapping prior to the actual file read/write and this allows systems based on this invention to attain faster speeds with much greater level of concurrency. In this way the present invention describes a mechanism for achieving true parallel access between the client component and the storage component of the cluster.

### BREIF DESCRIPTION OF THE DRAWINGS

The invention will now be described with reference to the accompanying drawings, in which

FIG. 1 of the accompanying drawings illustrates schematically a system comprising an exemplary data storage network with different network components in accordance with the present invention;

FIG. 2 illustrates the process in accordance with this invention for storage of data in the storage nodes (SN);

FIG. 3 illustrates a file identifier for a data file in accordance with this invention;

FIG. 4 illustrates a method of designating storage nodes in accordance with this invention;

FIG. 5 illustrates the changes that take place in the designation of storage nodes when an additional storage node is introduced in the system; and

FIG. 6 is a process of accessing data stored in any of the storage nodes of this invention.

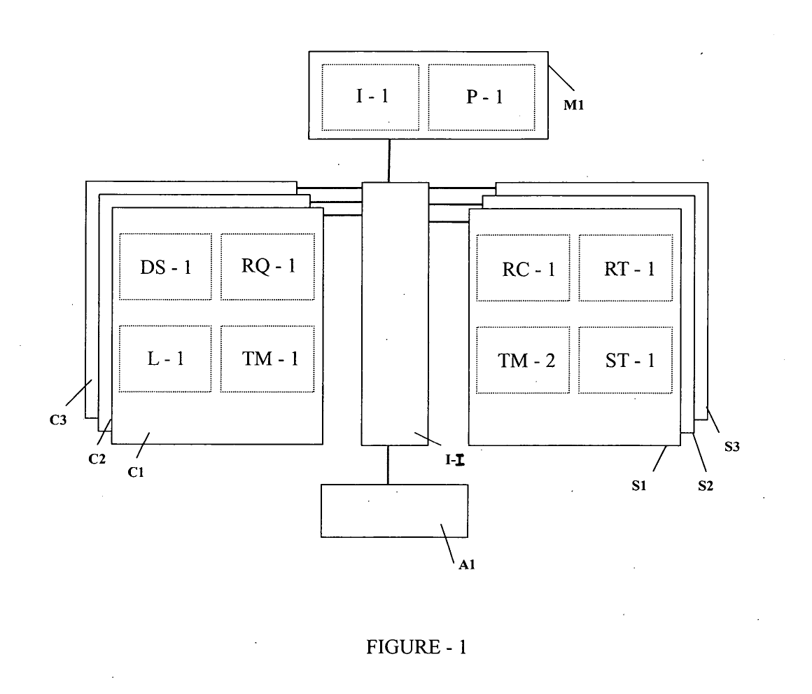

Directing attention to FIG. 1, of the accompanying drawings a system is illustrated comprising an exemplary data storage network with different network components. The apparatus of the invention includes a first set of a plurality of nodes (Client Nodes C1, C2, C3 . . . CN) each such node being defined by processing means including a “requester” means RQ-1, a “locator” means L-1, a “transmitter” means TM-1 and a “data-splitter” means DS-1. The client nodes for instance C1 also includes data storage means; memory means; input/output means and each said node [not shown in the figures] being further defined and addressed by a globally unique identifier hereafter referred to as the “parameters” for each of said client node C1, C2, C3.

The apparatus includes a second set of a plurality of nodes (Storage Nodes generally indicated by SN and particularly indicated by reference numerals S1, S2, S3 . . . ) differentiated form the first set C1, C2, C3 . . . by having enhanced data-storage capabilities represented by the reference numeral SM linked to storage means ST1 and further defined by memory means; Input/output means; and processing means including “receiver” means RC-1, “data-retrieval” means RT-1, and a “transmitter” means TM-2; each said node of the second set being further defined by a plurality of variable identifiers, a measurement of the total storage space and a measurement of the total available storage space in the node, together hereafter referred to as the “parameters” for each of said storage nodes.

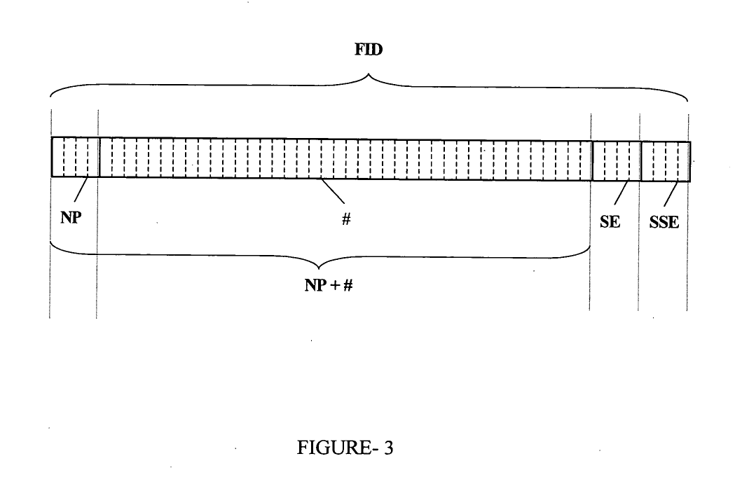

The apparatus further includes at least one meta-data node M1 adapted to manage data being inputted into and outputted form the second set of nodes and having processing means including “prefix generation” P 1 means, “file-identifier generation” means I-1 adapted to generate a globally unique identifier as seen in FIG. 3 for a data file; said file identifier FID being defined by
a “hash” element # that's derived from a hash of a pre-determined set of properties of the file
a “next-prefix” element NP that is derived from the “prefix-generation” means
a pre-determined “striping” element SE
a pre-determined “sizing” element SSE

The apparatus also includes at least one Administrative node A1 having tool and utilities for accessing and configuring abovementioned parameters associated with each of said nodes and disseminating modified parameters of one node to all other nodes irrespective of their set.

Finally the apparatus also includes an interconnect means I-I that is connected to the Input/Output means of the first set of nodes, the second set of nodes, the meta-data node and the Administrative node; and adapted to facilitate one-to-one, one-to-many, many-to-one and many-to-many data communication between the nodes.

The said nodes C1, C2, C3 . . . in the first set are adapted to initiate file operations within the computing environment; said file operations including file-create, file-read, file-write and file-rewrite operations.

The “data splitter” means DS-1 within the each node of the first set C1, C2, C3 . . . is adapted to split a file into smaller “stripes” of size defined by the “sizing” element dependent upon the file-identifier FID generated for that file.

The “locator” means L-1 within each node of the first set adapted to receive a “file-identifier” of a file and further adapted to provide the “requestor” RQ-1 and “transmitter” means TM-1 within the node with a designated sequence of nodes from the second set to which the requester or transmitter means respectively must request from or transmit data to respectively;

The “transmitter” means TM-1 within the each node of the first set is adapted to receive the stripes of the file from the “data-splitter” and the sequence of nodes in the second set from the “locator” and to transmit entire data contained in a file to a designated sequence of nodes from the second set S1, S2, S3 . . . .

The “requestor” means RQ-1 within the each node of the first set is adapted to receive a designated sequence of nodes from the second set from the “locator” means L-1 and further adapted to send a request for file stripe to an appropriate node in the second set.

The “prefix-generation” means P-1 at the meta-data node M1 is adapted to generate a “next-prefix” element for each node in the second set by using the parameters associated with that individual node.

The “identifier-generation” means I-1 at the meta-data node adapted to generate a unique identifier for a file and transmitting the identifier to the node within the first set responsible for creating a file.

The “receiver” means RC-1 within the each node of the second set is adapted to receive a request for data from the “requestor” or stripes of new or modified data form the “transmitter” within a node in the first set.

The “retrieval” means RT-1, upon trigger from the “receiver” means is adapted to retrieve data form the storage media associated with the storage nodes and to deliver it to the “transmitter” means of the second set.

The “storage” means ST-1 within the each node of the second set is adapted to receive data from the “receiver” and store data onto a storage media SM.

The “transmitter” means TM-2 within the each node of the second set is adapted to receive data from the “retrieval” means and further adapted to transmit data to the “requestor” means of the node from the first set that requested for that data.

In the system illustrated in FIG. 1 the nodes have been categorized according to their functionality. The sample configuration shown is not indicative of any limits to the number of each type of nodes. A typical configuration would consist of many client nodes C1, C2, C3 . . . (CN), many storage nodes S1, S2, S3 . . . (SN), and one or two meta date nodes M1 which act as file server nodes.

Each node is composed of differing hardware and software units and the actual hardware used could differ from system to system. The client nodes C1, C2, C3 . . . comprise any machine with computing resources running the client-side software (CS) of this invention. This includes Personal Computers, workstation, servers, gateways, bridges, routers, remote access devices and any device that has memory and processing capabilities. The system also does not differentiate between the exact operating systems (OS) running on each client and the OS is allowed to vary within the same network.

The network in accordance with this invention may be Local Area Network, Wide Area Network, Metropolitan Area Network or any other data communication network including the Internet. Each node in the system is either electrically connected via an network switch such as Ethernet switch, Infiniband switch or via wireless medium using a Wireless adapter and switch. A suitable data communication protocol allows messages or data to be passed from one node to the other.

A Storage Node S1, S2, S3 . . . (SN) has inbuilt memory and processing capabilities and can either have internal storage disks or can be directly attached to an external block storage device such as RAID arrays, which do not have any advanced processing capabilities of their own. SN utilizes its processing capabilities to export an interface that is an abstraction more intelligent than the traditional block/sector based addressing in block-based storage devices. This abstraction is referred to as ‘stripe’, which can be a file or a portion of a file. A ‘file’ or a ‘data file’ refers to any data set ranging from unstructured datasets such as audio, video or executable files to relational datasets such as database files. An SN internally manages the data storage and layout within its disks and does not make the internal block sector layout details visible to other entities attached to the network.

Each SN has it's a unique network address on Network and this allows any client CN to directly contact the appropriate SN for data. Although the network may internally have routers or bridges, it is assumed that each node within the DCE can contact any other node directly without having to go through a third node.

The system in FIG. 1 is physically similar to those of some of the existing parallel file systems. However in the system of the current invention, each node is virtualized over a separate circular identifier space composed of fixed number of digits. Each CN has a unique identifier within the identifier space for CNs that may be predetermined by the system administrator at the initialization of the systems. The SNs however are allocated a range of identifiers by a management function at Administrator node A1. At system initialization the SN ranges are equally spread across the circular namespace.

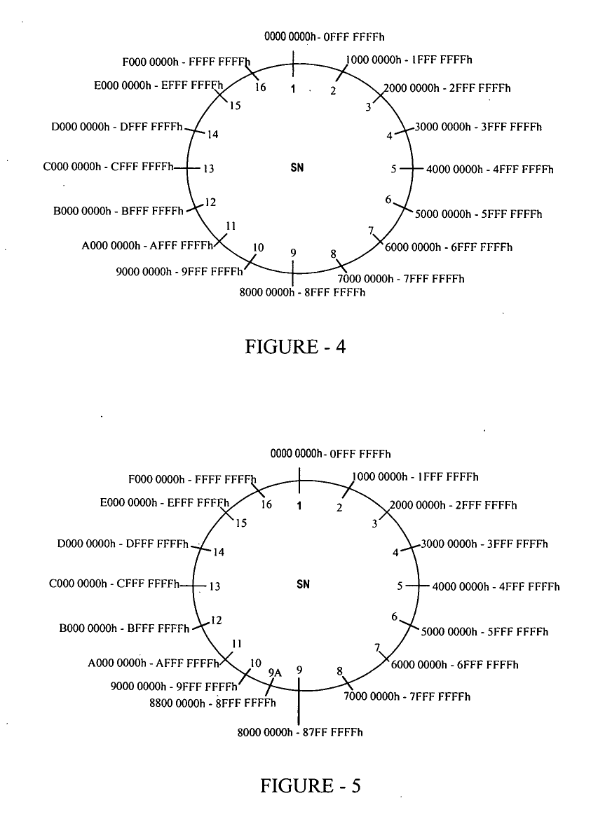

FIG. 4 of the accompanying drawings shows at the SN identifiers allocated to each SN at the initialization of a sample system containing 16 SN's. A 32-bit identifier space has been assumed in FIG. 4 and may be vary in different implementations of the invention.

The meta data node may not be virtualized in the aforementioned fashion unless there are many meta data nodes. Because the system eliminates many of the tasks commonly assigned to meta-data nodes, a need for more than 2 meta-data nodes per system in a failover configuration is not foreseen, but the possibility is not ruled out completely.

Each file stored within the system is either wholly stored at an SN or is split and spread across several SNs. The decision for this is a minimum file ‘stripe’ size configured by the administrator of the system. If the file size is greater than the configured ‘stripe’ size then the file is spread across more than one SN. At time of creation each file has a unique identifier allocated to it from the same SN identifier space. An SN stores and serves data in the form of stripes that may be a file or a subset of the file. In said system every stripe of a file has the same file identifier as shown in FIG. 3 with a few extra digits for the Stripe number suffixed to it, enough to differentiate between all stripes of the file.

For storage purposes, every file has a logical ‘head’ node and a logical ‘tail’ node associated with it that signify the SN nodes that hold the first and last objects of the file respectively. All stripes of the file are stored in a linear fashion beginning from the head node to the tail node within the circular namespace. If the number of stripes exceed the number of designated SNs then further stripes loop across the same set of SNs in a round-robin fashion.

Means of Keeping Clients updated about the Storage Server—Identifier Range Mappings are also provided. Just as the meta-data node maintains the identifiers and the utilization rates of SN, the CNs are kept updated by the Administrative node with a list of SN and their range of identifiers. Any change to this mapping is immediately notified by the Administrative node to all the CN. All operations on the file and actions thereof are performed keeping the range of identifiers for each SN in mind.

In one embodiment, it may be possible that the same SN may have two sets of ranges of identifiers and so for all purposes it appears as two SNs to the CN. For instance, one of the SN may have 320 GB of storage as compared to other SNs with 160 GB of storage. In this case a single SN shall be assigned two diametrically opposite range of identifiers. The CN will now have two ranges of identifiers that map to the same SN. This allows for maintaining the balance of stored data in a system with heterogeneous SNs.

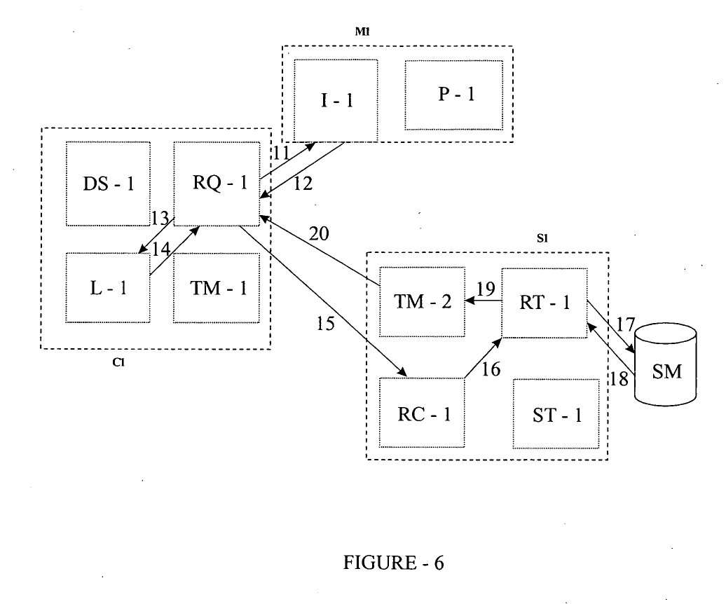

The invention also has means of locating a file or portion of a file based on the identifier generated earlier. A choice for an intelligent file identifier immediately allows all the CNs to exactly know the location of a file that is spread across the SNs. This helps eliminate an extra request to the meta-data node in existing systems. Once a file is created and its unique file identifier is known, the CN immediately knows where the file-head is stored. For instance, for the configuration in FIG. 6, if the stripe size is 100 kb and a CN wants to access the 444 kb offset of File A with identifier 233 f 8762 h (where the ‘h’ represents that the numbers are in hexadecimal notation) it automatically knows that the head node is SN 2 and the file is spread in a linear fashion. In this case it will directly request SN 6 that would be storing the 444 kb offset of File A.

In use, the apparatus of this invention will be used as follows.

Assuming that a client node has created data of size 2 TB. This data is required to be stored within the architecture of the apparatus of the invention. We presume for this example that at the time of storage requirement, the architecture has 16 storage nodes having spare storage capabilities. It is also assumed for this example that these storage nodes are located remotely and distantly from the client node.

These storage nodes are connected via the interconnect to the client node of this invention as are the client nodes in the system in a manner which permits one-one and one-many and many-many connectors. As stated earlier, the system also includes Administrator node and meta data node which are accessible by client nodes via said interconnect. For the purpose of convenience, the storage nodes have been designated as shown in FIG. 4. In accordance with this system and the apparatus of this invention these 16 storage nodes are assigned ranges in a 8 hexadecimal digit namespace. In practical use of the system, the storage nodes will have ranges designated by a 40 hexadecimal digit extension.

For instance, the first storage node would start at 00000000000000000000000000000000000000000000 and may terminate initially with the number 0FFFFFFFFFFFFFFFFFFFFFFFFFFFFFFFFFFFFFFF in hexadecimal representation.

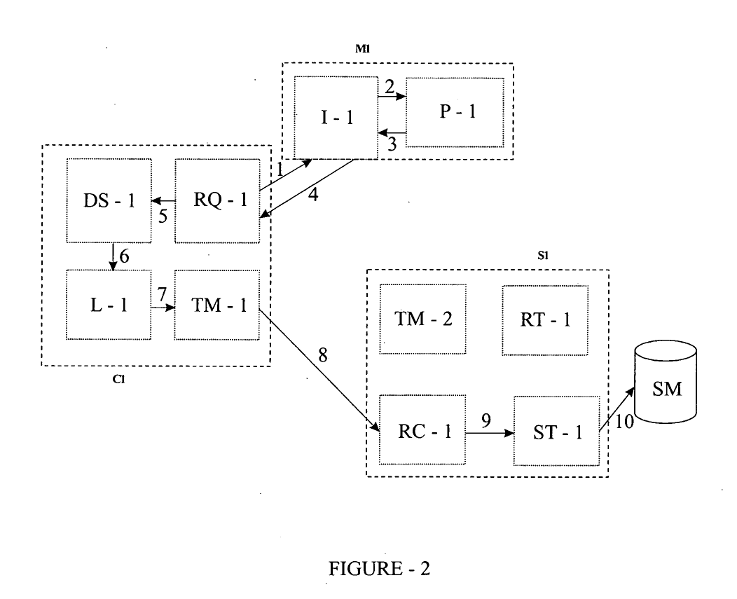

The first step of operation is creation of a file for the 2 TB data to be stored. Directing attention to FIG. 2, a request may be sent by the Requestor means R-1 at the client node to meta-data node for creation of the file identifier for the 2 TB data via Step 2 shown in the said Figure. On receipt of the request, meta-data node refers the request to the Identifier Generation Means I-1 reposed within the meta-data node. I-1 examines the properties of the file, such as its name, creator of the file, time of creation, permissions associated with the file and using these properties, it will invoke random value generator installed within itself, creating a random hash for the said file in hexadecimal system. Typically, in accordance with the preferred embodiment of this invention, the random number generated will have 40 places in hexadecimal representation. A typical number generated is 234ffabc3321f7634907a7b6d2fe64b3a8d9ccb4h where the ‘h’ stands for hexadecimal representation.

After generation of this FID the control transfers to a prefix generator P-1 which will prefix to the FID a next-prefix (NP) value having 4 places in hexadecimal system. P-1 normally prefixes a set of 0's in the usual scenario. However, when over a period of time, one of the Storage Node is noticed to be underutilized, an administrative involvement via the Administrative Node can convey to the Prefix Generations means to generate new prefixes in a fashion that ensures that the particular node is utilized more often. Similarly in case any particular Storage Node is overloaded P-1 can generate NP's that ensure the node is least used for storing new data. After completion of this step, two pre-determined suffixes are attached to the created hash, i.e. stripe size element (SSE) and the striping element (SE). Determination of the SSE is dependent upon the typical requirement of the client nodes. For instance, where text data is required to be stored, stripe sizes could be in 4 KB or 16 KB in length, whereas, if scientific or, audio video data is required to be stored, the file could be in 1 MB or 1 GB in length. In the present example, it may be convenient to have the stripe size of 512 MB. Within the system, 512 MB file size could be represented by a value like 0016. Similarly, value of the striping element SE, is again pre-determined on the basis of the storages nodes available in the system. For the purpose of this example, number of storage node selected is 8, and therefore, SE would be typically 0008. Therefore, the final FID generated by the meta-data node would also in this case 0000234ffabc3321f7634907a7b6d2fe64b3a8d9ccb400080016. This represents the complete final identifier, which is a permanent identifier for the entire file irrespective of where the bits and pieces data in the file are stored, on various storage nodes in the system, or, irrespective of any modification of data within the file. The FID is transferred from meta-data node to the client node via step 4 for attachment to the 2 TB data to be stored.

On receipt of the FID, the client node now activates its data splitter DS-1 means. DS-1, on receipt of the file identifier, splits the data into a set of stripes with size as determined from the FID. For this example, DS-1 records the stripe size element of the FID, which, in this case, is 0016 representing 512 MB, and, therefore, splits up the 2 TB data into 4,000 stripes, each of 512 MB discreetly mentioning each Stripe by digital envelopes. This accomplishes splitting of the files into stripes. The control is then passed on to the Locator Means L-1 which again, receives the FID, and reads the NP, the # and the SE. If the NP is a set of 0's then it is ignored and only the # value is considered, else the NP+# value is considered. The SN that owns the range of identifiers in which the said values fall defines the starting point to in the sequence of the storage node in which the stripes of the data are required to be eventually stored. This node is from the initial sequence of the symbols in NP or NP+# combination. In this particular example, the NP is 0's and so is ignored and initial symbols for the hash are 2-3-4- . . . , and therefore, the starting storage node (also referred elsewhere as the ‘head’ node for the file), as seen in FIG. 4, is identified by SN 2. The striping element SE, in this case, happens to be 0008. This implies that starting from the starting node SN 2, a total number of 8 nodes in sequence are to be used for storing stripes of the file. Following this further stripes are stored repeated across the 8 nodes in a Round Robin fashion.

In this particular example, it will happen as follows:

Stripe 1 will be stored in SN 2,

Stripe 2 will be stored in SN 3

Stripe 3 will be stored in SN 4

Stripe 4 will be stored in SN 5

Stripe 5 will be stored in SN 6

Stripe 6 will be stored in SN 7

Stripe 7 will be stored in SN 8

Stripe 8 will be stored in SN 10

Stripe 9 will be stored back in SN 2

Stripe 10 will be stored back in SN 3 and so on - - -

The transmitter TM-1 interprets the information created by DS-1 and L-1. It then sends each stripe to the destination storage node via one or more of Step 8 until the entire data is stored in this fashion.

The invention envisages possibility of addition and deletion of the storage nodes within the system architecture. Assuming for the purpose of this example as seen in FIG. 5 the storage node 9A is introduced between SN 9 and SN 10, resulting in a range of storage node being modified as follows;

The original range for SN 9 was 80000000h-8FFFFFFFh and for SN 10 was 90000000h-9FFFFFFFh. These will now become SN 9 having range of 80000000h-87FFFFFFh, SN 9A having range of 88000000h-8FFFFFFFh and SN 10 being unchanged at 90000000h-9FFFFFFFh, in which eventuality stripes residing on SN 10 will be relocated to SN 9A in order to maintain consistency of the file data.

In the event of a removal of Storage node from the System architecture, the stripes of data will realign themselves as described for the case of addition of a new Storage Node into the system.

Directing attention now to FIG. 6, for retrieval of the 2 TB data or a portion there of, the Requestor RQ-1 on the client node in step 11 sends a request to the identifier generation means I-1 of meta-data node M-1. I-1 is linked to a database (not specifically shown) that has a list of identifier for every file in the stores within the Storage nodes of the system. M-1 lookups the identifier corresponding to the said file from the database and returns it via Step 12 to RQ-1. This identifier for the 2 TB data would be the same one that was created as aforesaid and will be in the same form as the FID shown in Figure. RD-1 on receipt of the FID, passes it to the Locator Means L-1 via Step 13 which analyses the FID and reads its various elements viz. the next-prefix element, the hash element and the Striping element. Based on the methodology described for Storage of the newly created data, L-1 generates a list of Storage Nodes that house the various stripes of the file including the Starting Storage node that houses the first stripe for the file. This information is returned to RQ-1 via Step 14. On receipt of this information RQ-1 contacts the appropriate Storage Node according to the portion of the file required (Step 15).

The Receiver means RC-1 at one of the Storage Nodes contacted by RQ-1, receives one such request and forwards it to the Retrieval mean RT-1 via Step 16. RT-1 picks up the data from the Storage Media via Steps 17 and 18. This data is then forwarded to the Transmitter means TM-2 via Step 19. TM-2 transmits the entire data back to RQ-1.

For instance, if the information is stored in 5 stripes then RQ-1 will send 5 separate requests to 5 Storage Nodes in sequence and receive the desired stripes which will be further be merged at C1 in the usual manner. The receipt of the Data stripes from the accessed Storage Nodes may not be necessarily in the same order as that of the requests sent. For instance if one of the 5 Storage nodes is busy then its response may come late.

Although for the purposes of this example the striping element and the stripe-size element have been uniquely retained for the life of the file, it is within the scope of this invention that these elements of the file-identifier are subject to alteration during the life of the file. Such alteration, for instance the Striping element may change in response to addition of nodes. For instance in the above example the striping element designator may change from 0008 to 0009 when an additional Storage Node is introduced in the system architecture. This will involve restructuring of the stripes across 9 nodes.

Similarly if a user wishes to change the sizing element to greater or smaller size similar changes will effected in the stripes and the Storage of the stripes across the Storage nodes.

A significant feature of the invention is the fact that in the system architecture of this invention the meta-data node is isolated from the function of continuous data storage and retrieval functions allowing the meta-data node to perform more important functions according to its capabilities. For instance in a highly data-intensive environment such as a Seismic Data Processing System there is demand to satisfy thousands of file operations per second. In the prior art a file server is responsible for maintaining a consistence mapping of the various stripes of the file with the Storage Nodes they are stored within. The file server is required to be contacted for each of the file operation and this result in the file server node becoming a bottleneck and degrading the performance of the system as a whole. In accordance with the apparatus of the present invention, once the FID is received by the Client node it does need to access the meta-data node for further interaction with the Storage nodes for the said file this eliminating the requirement to access the file server for each and every file Input/Output operation.

Various modifications to the above invention description and its preferred embodiment will be readily apparent to those skilled in the art and the general principles defined herein may be applied to other embodiments and applications without departing from the spirit and scope of the invention. Thus, it is intended that the present invention be accorded the widest scope consistent with the principles and features disclosed herein.

1. A distributed computing environment system comprising:
a first set of a plurality of nodes (Client Nodes) each such node being defined by processing means including a “requester” means, a “locator” means, a “transmitter” means and a “data-splitter” means; data storage means; memory means; input/output means and each said node being further defined and addressed by a globally unique identifier hereafter referred to as the “parameters” for each of said client node;
a second set of a plurality of nodes (Storage Nodes) differentiated form the first set by having enhanced data-storage capabilities and further defined by memory means; Input/output means; and processing means including “receiver” means, “data-retrieval” means and a “transmitter” means; each said node of the second set being further defined by a plurality of variable identifiers, a measurement of the total storage space and a measurement of the total available storage space in the node, together hereafter referred to as the “parameters” for each of said storage nodes;
at least one meta-data node adapted to manage data, including data in the form of data files, being inputted into and outputted form the second set of nodes [storage nodes] and having a database of all data files and their respective identifier stored in the said environment, processing means including “prefix generation” means, “file-identifier generation” means adapted to generate a globally unique identifier for a data file; said file identifier being defined by
a “head” element that's derived from a hash of a pre-determined set of properties of the file
a “next-prefix” element that is derived from the “prefix-generation” means
a pre-determined “striping” element
a pre-determined “sizing” element
at least one Administrative node having tool and utilities for accessing and configuring abovementioned parameters associated with each of said nodes and disseminating modified parameters of one node to all other nodes irrespective of their set;
an interconnect means that is connected to the Input/Output means of the first set of nodes [client nodes], the second set of nodes [storage nodes], the meta-data node and the Administrative node; and adapted to facilitate one-to-one, one-to-many, many-to-one and many-to-many data communication between the nodes;
said nodes in the first set adapted to initiate file operations within the computing environment; said file operation including file-create, file-read and file-write operations;
said “data splitter” means within the each node of the first set adapted to split a file into smaller “stripes” of size defined by the “sizing” element dependent upon the file-identifier generated for that file;
said “locator” means within each node of the first set adapted to receive a “file-identifier” of a file and further adapted to provide the “requestor” and “transmitter” means within the node with a designated sequence of nodes from the second set to which the requestor or transmitter means respectively must request from or transmit data to respectively;
said “transmitter” means within the each node of the first set adapted to receive the stripes of the file from the “data-splitter” and the sequence of nodes in the second set from the “locator” and to transmit entire data contained in a file to a designated sequence of nodes from the second set;
said “requestor” means within the each node of the first set adapted to receive a designated sequence of nodes from the second set from the “locator” means and further adapted to send a request for file stripe to an appropriate node in the second set;
said “prefix-generation” means at the meta-data node adapted to generate a “next-prefix” element for each node in the second set by using the parameters associated with that individual node;
said “identifier-generation” means at the meta-data node adapted to generate a unique identifier for a file and transmitting the identifier to the node within the first set responsible for creating a file;
said “receiver” means within the each node of the second set adapted to receive a request for data from the “requester” or stripes of new or modified data form the “transmitter” within a node in the first set;
said “retrieval” means, upon trigger from the “receiver” means adapted to retrieve data form the storage media associated with the storage nodes and to deliver it to the “transmitter” means of the second set;
said “storage” means adapted to receive data from the “receiver” and store data onto a storage media; and
said “transmitter” means adapted to receive data from the “retrieval” means and further adapted to transmit data to the “requestor” means of the node from the first set that requested for that data.

2. The apparatus as claimed in claim 1 wherein the meta-data node comprises a combination of more than one nodes that cooperate with each other to provide the said meta date node.

3. The apparatus as claimed in claim 1 wherein the Administrative node is the meta-data node.

4. The apparatus as claimed in claim 1 wherein the Storage media of the storage node is external to the second set of nodes and is externally connected to the nodes.

5. The apparatus as claimed in claim 1 wherein there are more than one instances of the “requester” and “transmitter” means in the first set of nodes to allow for parallel execution of requests from applications being executed on the node.

6. The apparatus as claimed in claim 1 wherein there are more than one instances of the “receiver” and “transmitter” means in the second set of nodes to allow for parallel execution of requests from multiple nodes in the first set.

7. The apparatus as claimed in claim 1 wherein the “requestor” and the “transmitter” means in the first set of nodes are coupled into a single component.

8. The apparatus as claimed in claim 1 wherein the “receiver” and the “transmitter” means in the second set of nodes are coupled into a single component.

9. The apparatus as claimed in claim 1 wherein the “identifier generation” and the “prefix-generation” means are coupled into a single component on the meta-data node.

10. The apparatus as claimed in claim 1 wherein the interconnect includes multiple devices that are directly interconnected to allow bi-directional communication between all of the nodes connected to any of the device.

11. The apparatus as claimed in claim 1 wherein the interconnect includes multiple devices that are indirectly connected via a secondary network such as the Internet and allow for bi-directional communication between all of the said nodes.

12. The apparatus as claimed in claim 1 wherein the meta-data node is one of the nodes in the first set of nodes.

13. The apparatus as claimed in claim 1 wherein the client nodes are characterized by more than one globally unique identifier.

14. The apparatus as claimed in claim 1 wherein the Storage nodes are characterized by more than one set of variable identifiers.

15. A method of storing a data file in a distributed computing environment using the apparatus in accordance claims 1 comprising the following steps:
I. Providing an environment comprising a first set of a plurality of client nodes each said client node having data splitter means, locator means, requestor, transmitter means, a second set of plurality of nodes (Storage nodes) each said node being defined by a a range of identifiers and comprising a transmitter means, a receiver means, a storage means and a retrieval means, said storage means associated with storage media; at least one meta-data node, said meta-data node comprising a identifier generation means and a prefix generation means and an interconnect for communication between the said nodes;
II. sending a request from the requester means of a client node in possession of the said data file in need of storage, to the identifier generation means of a meta-data node for generating a identifier for the said data file;
III. receiving by the identifier generation means a next-prefix from the Prefix generation means and generating a unique identifier, said identifier consisting of a next-prefix element, a hash element, a striping element and a stripe size element; the said striping and stripe size elements being predetermined;
IV. sending, from the identifier generation means, the generated identifier to the requestor at the client node and forwarding the said identifier to the data splitter means within the same node;
V. splitting the said data file by the data splitter means into stripes of data as per the stripe size element interpreted from the said identifier;
VI. sending the identifier together with the stripes to the locator means and generating a a list containing set of destination storage nodes for the said stripes by matching the next prefix and hash elements of the said file identifier with the range of identifiers of each storage nodes;
VII. sending the said list and the said stripes to the transmitter means
VIII. transmitting the said data file at least one stripe at a time sequentially to each destination Storage node present in the said list looping across the list in a round robin manner.

16. A method of accessing stored data from a data file in a distributed computing environment using the apparatus as claimed in claim 1 comprising the following steps:
I. Providing an environment comprising a first set of a plurality of client nodes each said client node having data splitter means, locator means, requester, transmitter means, a second set of plurality of nodes (Storage nodes) each said node being defined by a a range of identifiers and comprising a transmitter means, a receiver means, a storage means and a retrieval means, said storage means associated with storage media; at least one meta-data node, said meta-data node comprising a identifier generation means and a prefix generation means and a database of all files and their respective identifier stored in the said environment, and an interconnect for communication between the said nodes;
II. Sending a request to the meta data node for a file identifier of the said data file receiving by the requester means the identifier for the said file;
III. sending from the requestor means, the identifier for the said file to the locator means within the same node and receiving a list of a set of Storage nodes that store stripes of the said file
IV. sending a requesting from the requester means to the receiver means of one of the Storage nodes of the said set;
V. receiving the request at each of the storage nodes in the set and processing the request for retrieving at least one stripe of the said data stored in the said storage nodes;
VI. transmitting of the rerieved at least one stripe by the transmitter means of the storage node to the client node

17. The method of claim 16, which includes the step of storing the file identifier associated with a data file for future access of the same data file thereby eliminating need for the client node the access the meta data node for subsequent access to said file.

18. A method of modifying a data file stored in a distributed storage environment using the apparatus as claimed in claim 1, comprising the steps of:
I. acccesing the file in accordance with the method as claimed in claim 16;
II. carrying out in the client node modification of the data;
III. storing the modified data file in accordance with the method as claimed in claim 15.
